(19) United States
(12) Patent Application Publication
(10) Pub. No.: US 2020/0261977 A1
(43) Pub. Date: Aug. 20, 2020

(54) SCAN FIELD VARIATION COMPENSATION

(71) Applicant: General Electric Company, Schenectady, NY (US)

(72) Inventors: Justin Mamrak, Loveland, OH (US); MacKenzie Ryan Redding, Mason, OH (US)

(21) Appl. No.: 16/761,745

(22) PCT Filed: Nov. 2, 2018
(86) PCT No.: PCT/US2018/058884

§ 371 Date: May 5, 2020

Related U.S. Application Data
(60) Provisional application No. 62/584,477, filed on Nov. 10, 2017.

(51) Int. Cl. B22F 3/105; B33Y 10/00; B33Y 50/02

(52) U.S. Cl. CPC B22F 3/1055; B22F 2003/1057; B33Y 50/02; B33Y 10/00

(57) ABSTRACT

A method, apparatus, and program for additive manufacturing. In one aspect, the additive manufacturing method includes irradiating a build material (416) to form a first solidified portion within a first scan region (812A) using an irradiation source (401) of a build unit (400). At least one of the build unit and a build platform may be moved to irradiate a second scan region (812B), wherein an irradiation source (401) directing mechanism is adjusted to compensate for a misalignment between the first scan region and the second scan region (640).

### PRIORITY INFORMATION

The present applicant claims priority to U.S. Provisional Patent Application Ser. No. 62/584,477 titled “Scan Field Variation Compensation” filed on Nov. 10, 2017, the disclosure of which is incorporated by reference herein.

### FIELD

The disclosure relates to an improved method and apparatus for scanning a build material for use in additive manufacturing.

### BACKGROUND

Additive manufacturing (AM) techniques may include electron beam freeform fabrication, laser metal deposition (LIVID), laser wire metal deposition (LMD-w), gas metal arc-welding, laser engineered net shaping (LENS), laser sintering (SLS), direct metal laser sintering (DMLS), electron beam melting (EBM), powder-fed directed-energy deposition (DED), and three dimensional printing (3DP), as examples. AM processes generally involve the buildup of one or more materials to make a net or near net shape (NNS) object in contrast to subtractive manufacturing methods. Though “additive manufacturing” is an industry standard term (ISO/ASTM52900), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. As an example, a particular type of AM process uses an energy beam, for example, an electron beam or electromagnetic radiation such as a laser beam, to sinter or melt a powder material and/or wire-stock, creating a solid three-dimensional object in which a material is bonded together.

Selective laser sintering, direct laser sintering, selective laser melting, and direct laser melting are common industry terms used to refer to producing three-dimensional (3D) objects by using a laser beam to sinter or melt a fine powder. For example, U.S. Pat. Nos. 4,863,538 and 5,460,758 describe conventional laser sintering techniques. More specifically, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Electron beam melting (EBM) utilizes a focused electron beam to melt powder. These processes involve melting layers of powder successively to build an object in a metal powder.

AM techniques, examples of which are discussed above and throughout the disclosure, may be characterized by using a laser or an energy source to generate heat in the powder to at least partially melt the material. Accordingly, high concentrations of heat are generated in the fine powder over a short period of time. The high temperature gradients within the powder during buildup of the component may have a significant impact on the microstructure of the completed component. Rapid heating and solidification may cause high thermal stress and cause localized non-equilibrium phases throughout the solidified material. Further, since the orientation of the grains in a completed AM component may be controlled by the direction of heat conduction in the material, the scanning strategy of the laser in an AM apparatus and technique becomes an important method of controlling microstructure of the AM built component. Controlling the scanning strategy in an AM apparatus is further crucial for developing a component free of material defects, examples of defects may include lack of fusion porosity and/or boiling porosity.

FIG. 1 is schematic diagram showing a cross-sectional view of an exemplary conventional system 110 for direct metal laser sintering (DMLS) or direct metal laser melting (DMLM). The apparatus 110 builds objects, for example, the part 122, in a layer-by-layer manner (e.g., layers L1, L2, and L3, which are exaggerated in scale for illustration purposes) by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer (e.g., layer L1) of the object being built under control of the galvo scanner 132. The build plate 114 is lowered and another layer (e.g., layer L2) of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder, for example, by blowing or vacuuming, machining, sanding or media blasting. Further, conventional post processing may involve removal of the part 122 from the build platform/substrate through machining, for example. Other post processing procedures include a stress release process. Additionally, thermal and chemical post processing procedures can be used to finish the part 122.

The abovementioned AM processes is controlled by a computer executing a control program. For example, the apparatus 110 includes a processor (e.g., a microprocessor) executing firmware, an operating system, or other software that provides an interface between the apparatus 110 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly. One having ordinary skill in the art would fully appreciate the abovementioned control program may be applicable to any of the abovementioned AM processes. Further, the abovementioned computer control may be applicable to any subtractive manufacturing or any pre or post processing techniques employed in any post processing or hybrid process.

When forming a component using an AM process, various process parameters of the AM apparatus during a layer-by-layer build can have a significant impact on the quality of the component and the dimensional accuracy of the completed component. AM apparatuses have a significant number of components which all must be calibrated to create consistent and dimensionally accurate components. For example, an in the abovementioned apparatus, a galvanometer may be used as a directing device to direct a laser beam to fuse a region of powder during each layer of the build. In the example, correct calibration of the galvanometer is critical to assure an accurate build. Further, in the AM apparatus disclosed below, there also exists a need to calibrate the movement of a build unit and/or a build platform.

### BRIEF DESCRIPTION

Aspects and advantages will be set forth in part in the following description, or may be obvious from the description, or may be learned through practice of the invention.

In one aspect, a method for additive manufacturing is disclosed. The method may comprise irradiating a build material to form a first solidified portion within a first scan region using an irradiation source of a build unit. The method further comprises moving the build unit to a second scan region and irradiating a build material to form a second solidified portion within the second scan region, wherein an irradiation source directing mechanism is adjusted to compensate for a misalignment between the first scan region and the second scan region. In one aspect, the irradiation source may be a laser and the irradiation source directing mechanism may be a galvanometer. The irradiation source directing mechanism may be adjusted by applying an offset value to a signal received at the irradiation source directing mechanism. Further, the irradiation source directing mechanism may be adjusted by altering a drive voltage of the irradiation source directing mechanism.

In one aspect, a method for forming an object using an additive manufacturing apparatus is disclosed. The method may comprise irradiating a build material on a mobile build platform to form a first solidified portion within a first scan region using an irradiation source of a build unit. The method may further comprise moving the build platform to align the build unit with a second scan region and irradiating a build material to form a second solidified portion within the second scan region, wherein the irradiation source directing mechanism is adjusted to compensate for a misalignment between the first scan region and the second scan region. The irradiation source may be a laser and the irradiation source directing mechanism may be a galvanometer. The irradiation source directing mechanism may be adjusted by applying an offset value to a signal received at the irradiation source directing mechanism. In one aspect of the disclosure, the irradiation source directing mechanism is adjusted by altering a drive voltage of the irradiation source directing mechanism.

In another aspect, a non-transitory computer readable medium storing a program configured to cause a computer to execute an additive manufacturing method is disclosed. The additive manufacturing method may comprise irradiating a build material to form a first solidified portion within a first scan region using an irradiation source of a build unit. At least one of the build unit and a build platform may be moved to irradiate a second scan region, wherein an irradiation source directing mechanism is adjusted to compensate for a misalignment between the first scan region and the second scan region. In one aspect the irradiation source is a laser and the irradiation source directing mechanism is a galvanometer. The irradiation source directing mechanism may be adjusted applying an offset value to a signal received at the irradiation source directing mechanism. In another aspect, the irradiation source directing mechanism may be adjusted by altering a drive voltage of the irradiation source directing mechanism.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 is a side view diagram of a conventional additive manufacturing technique used to form at least part of a component;

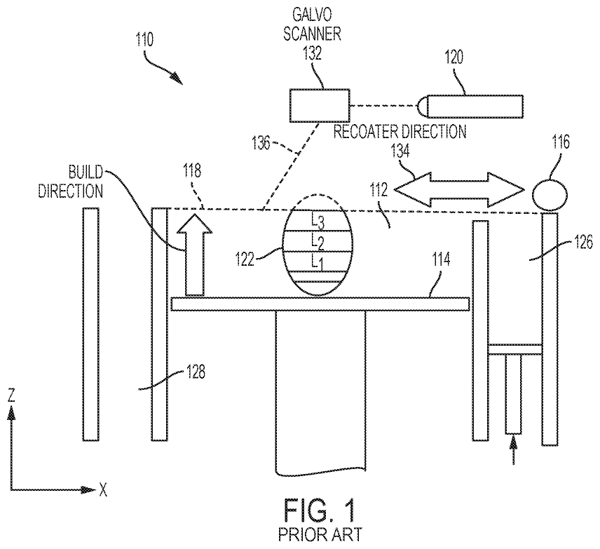

FIG. 2 is a side view cross section of a build unit in accordance with one aspect of the disclosure;

FIG. 3 is a side view cross section of a build unit and part of the rotating build platform of an additive manufacturing apparatus in accordance with one aspect of the disclosure;

FIG. 4 is a simplified top view of a large scale additive manufacturing apparatus with two build units according to an aspect of the disclosure;

FIG. 5 is a simplified side view of a build unit according to an aspect of the disclosure;

FIG. 6 is a flowchart showing one example process for calibration in accordance with one aspect of the disclosure; and

FIG. 7 is a top view showing several examples of calibration in accordance with one aspect of the disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

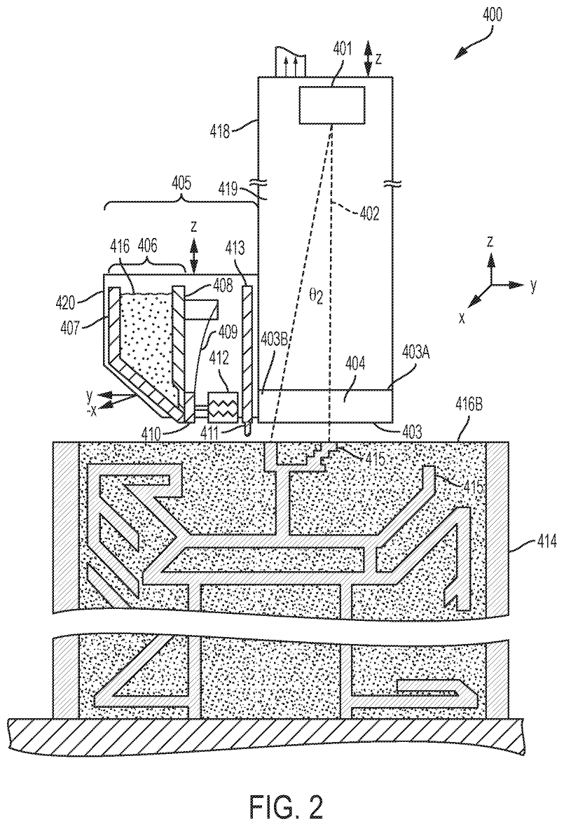

FIG. 2 shows an example of one embodiment of a large-scale AM apparatus usable with the present invention. The apparatus comprises a positioning system (not shown), a build unit 400 comprising an irradiation emission directing device 401, a laminar gas flow zone 404, and a build plate beneath an object being built 415. The maximum build area is defined by the positioning system (not shown), instead of by a powder bed as with conventional systems, and the build area for a particular build can be confined to a build envelope 414 that may be dynamically built up along with the object. In general, the positioning system used in the present invention may be any multidimensional positioning system such as a gantry system, a delta robot, cable robot, robot arm, etc. The irradiation emission directing device 401 may be independently moved inside of the build unit 400 by a second positioning system (not shown). The atmospheric environment outside the build unit, i.e. the “build environment,” or “containment zone,” may be controlled such that the oxygen content is reduced relative to typical ambient air, and so that the environment is at reduced pressure. In some embodiments, the recoater used is a selective recoater. One embodiment of a selective recoater 411 is illustrated in FIG. 2. It is noted that while FIG. 2 shows an example, the current invention is also applicable to a single stationary scanner, a plurality of stationary scanners, and/or a plurality of stationary and/or mobile build units.

There may also be an irradiation source that, in the case of a laser source, originates the photons comprising the laser irradiation that is directed by the irradiation emission directing device. When the irradiation source is a laser source, then the irradiation emission directing device may be, for example, a galvo scanner, and the laser source may be located outside the build environment. Under these circumstances, the laser irradiation may be transported to the irradiation emission directing device by any suitable means, for example, a fiber-optic cable. When the irradiation source is an electron source, then the electron source originates the electrons that comprise the e-beam that is directed by the irradiation emission directing device. When the irradiation source is an electron source, then the irradiation emission directing device may be, for example, a deflecting coil. When a large-scale additive manufacturing apparatus according to an embodiment of the present invention is in operation, if the irradiation emission directing devices directs a laser beam, then generally it is advantageous to include a gasflow device 403 providing substantially laminar gas flow zone. An electron-beam may also be used in instead of the laser or in combination with the laser. An e-beam is a well-known source of irradiation. For example, U.S. Pat. No. 7,713,454 to Larsson titled “Arrangement and Method for Producing a Three-Dimensional Product” (“Larsson”) discusses e-beam systems, and is incorporated herein by reference.

The gasflow device 403 may provide gas to a pressurized outlet portion 403A and a vacuum inlet portion 403B which may provide gas flow to a gasflow zone 404, and a recoater 405. Above the gasflow zone 404 there is an enclosure 418 which may contain an inert environment 419. The recoater 405 may include a hopper 406 comprising a back plate 407 and a front plate 408. The recoater 405 also has at least one actuating element 409, at least one gate plate 410, a recoater blade 411, an actuator 412, and a recoater arm 413. The recoater is mounted to a mounting plate 420. FIG. 2 also shows a build envelope 414 that may be built by, for example, additive manufacturing or Mig/Tig welding, an object being formed 415, and powder 416 contained in the hopper 406 used to form the object 415. In this particular example, the actuator 412 activates the actuating element 409 to pull the gate plate 410 away from the front plate 408. In an embodiment, the actuator 412 may be, for example, a pneumatic actuator, and the actuating element 409 may be a bidirectional valve. In an embodiment, the actuator 412 may be, for example, a voice coil, and the actuating element 409 may be a spring. There is also a hopper gap 417 between the front plate 408 and the back plate 407 that allows powder to flow when a corresponding gate plate is pulled away from the powder gate by an actuating element. The powder 416, the back plate 407, the front plate 408, and the gate plate 410 may all be the same material. Alternatively, the back plate 407, the front plate 408, and the gate plate 410 may all be the same material, and that material may be one that is compatible with any desired material, such as cobalt-chrome for example. In this particular illustration of one embodiment of the present invention, the gas flow in the gasflow zone 404 flows in the x direction, but could also flow in any desired direction with respect to the build unit. The recoater blade 411 has a width in the x direction. The direction of the irradiation emission beam when θ2 is approximately 0 defines the z direction in this view. The gas flow in the gasflow zone 404 may be substantially laminar. The irradiation emission directing device 401 may be independently movable by a second positioning system (not shown). This illustration shows the gate plate 410 in the closed position.

Further it is noted that while the abovementioned selective powder recoating mechanism 405 only includes a single powder dispenser, the powder recoating mechanism may include multiple compartments containing multiple different material powders are also possible. Similarly, the abovementioned apparatus may include plurality of recoater mechanisms.

When the gate plate 410 in the open position, powder in the hopper is deposited to make fresh powder layer 416B, which is smoothed over by the recoater blade 411 to make a substantially even powder layer. In some embodiments of the present invention, the substantially even powder layer may be irradiated at the same time that the build unit is moving, which would allow for continuous operation of the build unit and thus faster production of the object.

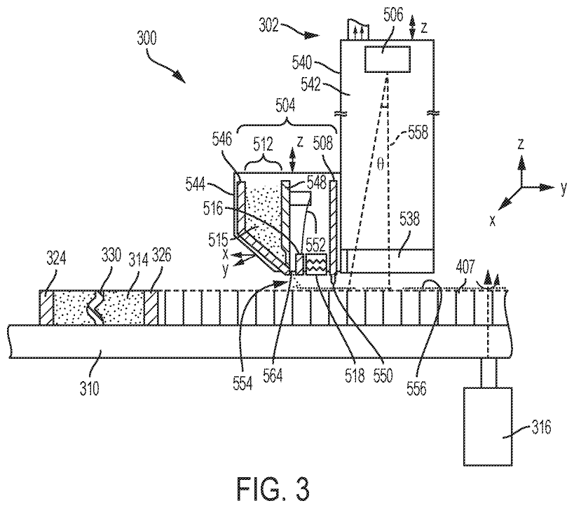

FIG. 3 shows a side view of a manufacturing apparatus 300 including details of the build unit 302, which is pictured on the far side of the build platform. The mobile build unit 302 includes an irradiation beam directing mechanism 506, a gas-flow mechanism (e.g., similar to gasflow device 403) with a gas inlet and gas outlet (not shown) providing gas flow to a gas flow zone in direction 538, and a powder recoating mechanism 504. In this example, the flow direction is substantially along the X direction. Above the gas flow zone 538, there may be an enclosure 540 that contains an inert environment 542. The powder recoating mechanism 504, which is mounted on a recoater plate 544, has a powder dispenser 512 that includes a back plate 546 and a front plate 548. The powder recoating mechanism 504 also includes at least one actuating element 552, at least one gate plate 516, a recoater blade 550, an actuator 518 and a recoater arm 508. In this embodiment, the actuator 518 activates the actuating element 552 to pull the gate plate 516 away from the front plate 548, as shown in FIG. 3. There is also a gap 564 between the front plate 548 and the gate plate 516 that allows the powder to flow onto the rotating build platform 310 when the gate plate 516 is pulled away from the front plate 548 by the actuating element 552. The rotating build platform 310 may be rotatably controlled by a motor 316.

FIG. 3 shows a build unit 302 with the gate plate 516 at an open position. The powder 515 in the powder dispenser 512 is deposited to make a fresh layer of powder 554, which is smoothed over a portion of the top surface (i.e. build or work surface) of the rotating build platform 310 by the recoater blade 510 to make a substantially even powder layer 556 which is then irradiated by the irradiation beam 558 to a fused layer that is part of the printed object 330. In some embodiments, the substantially even powder layer 556 may be irradiated at the same time as the build unit 302 is moving, which allows for a continuous operation of the build unit 302 and hence, a more time-efficient production of the printed or grown object 330. The object being built 330 on the rotating build platform 310 is shown in a powder bed 314 constrained by an outer build wall 324 and an inner build wall 326. In this particular illustration of one embodiment of the present invention, the gas flow in the gasflow zone 538 flows in the x direction, but could also flow in any desired direction with respect to the build unit.

It is noted that while the abovementioned selective powder recoating mechanism 504 only includes a single powder dispenser, the powder recoating mechanism may include multiple compartments containing multiple different material powders are also possible. Further, while a single recoater apparatus is shown, the invention is applicable to an apparatus having a plurality of recoater apparatuses.

Further, it should be appreciated that according to alternative embodiments, the abovementioned additive manufacturing machines and build units may be configured for using a “binder jetting” process of additive manufacturing. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. For example, the liquid binding agent may be a photo-curable polymer or another liquid bonding agent. Other suitable additive manufacturing methods and variants are intended to be within the scope of the present subject matter.

Additional details for a build units and positioning mechanisms for a single and/or multiple units that can be used in accordance with the present invention may be found in U.S. patent application Ser. No. 15/610,177, titled “Additive Manufacturing Using a Mobile Build Volume,” with attorney docket number 037216.00103, and filed May 31, 2017; U.S. patent application Ser. No. 15/609,965, titled “Apparatus and Method for Continuous Additive Manufacturing,” with attorney docket number 037216.00102, and filed May 31, 2017; U.S. patent application Ser. No. 15/610,113, titled “Method for Real-Time Simultaneous Additive and Subtractive Manufacturing With a Dynamically Grown Build Wall,” with attorney docket number 037216.00108, and filed May 31, 2017; U.S. patent application Ser. No. 15/610,214, titled “Method for Real-Time Simultaneous and Calibrated Additive and Subtractive Manufacturing,” with attorney docket number 037216.00109, and filed May 31, 2017; U.S. patent application Ser. No. 15/609,747, titled “Apparatus and Method for Real-Time Simultaneous Additive and Subtractive Manufacturing with Mechanism to Recover Unused Raw Material,” with attorney docket number 037216.00110, and filed May 31, 2017; U.S. patent application Ser. No. 15/406,444, titled “Additive Manufacturing Using a Dynamically Grown Build Envelope,” with attorney docket number 037216.00061, and filed Jan. 13, 2017; U.S. patent application Ser. No. 15/406,467, titled “Additive Manufacturing Using a Mobile Build Volume,” with attorney docket number 037216.00059, and filed Jan. 13, 2017; U.S. patent application Ser. No. 15/406,454, titled “Additive Manufacturing Using a Mobile Scan Area,” with attorney docket number 037216.00060, and filed Jan. 13, 2017; U.S. patent application Ser. No. 15/406,461, titled “Additive Manufacturing Using a Selective Recoater,” with attorney docket number 037216.00062, and filed Jan. 13, 2017; U.S. patent application Ser. No. 15/406,471, titled “Large Scale Additive Machine,” with attorney docket number 037216.00071, and filed Jan. 13, 2017, the disclosures of which are incorporated herein by reference.

One advantage of the abovementioned additive machines is that, in some embodiments, the build plate may be vertically stationary (i.e. in the z direction). This permits the build plate to support as much material as necessary, unlike the prior art methods and systems, which require some mechanism to raise and lower the build plate, thus limiting the amount of material that can be used. Accordingly, large scale additive machines are particularly suited for manufacturing an object within a large build envelope. With respect to the build envelope, precision and quality of the envelope may be relatively unimportant, such that rapid build techniques are advantageously used. In general, the build envelope may be built by any suitable means, for instance by Mig or Tig welding, or by laser powder deposition. If the wall is built by additive manufacturing, then a different irradiation emission directing device can be used to build than wall than is used to build the object. This is advantageous because building the wall may be done more quickly with a particular irradiation emission directing device and method, whereas a slower and more accurate directing device and method may be desired to build the object.

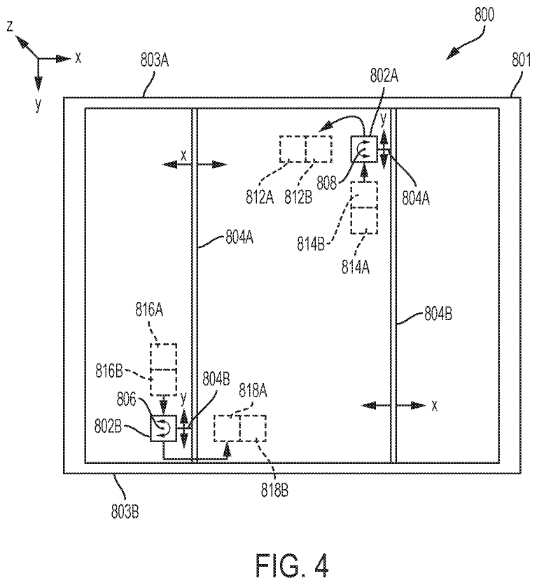

As one example shown in FIG. 4, the systems and methods of the present invention may use two or more build units to build one or more object(s). The number of build units, objects, and their respective sizes are only limited by the physical spatial configuration of the apparatus. FIG. 4 shows a top down view of a large-scale additive manufacturing machine 800 according to an embodiment of the invention. There are two build units 802A and 802B mounted to a positioning system 801. There are z crossbeams 803A and 803B for moving the build units in the z direction. There are x crossbeams 804A and 804B for moving the build units in the x direction. The build units 802A and 802B are attached to the x crossbeams 804A and 804B by mechanisms 805A and 805B that move the units in the y direction. The object(s) being formed are not shown in this view. A build envelope (also not shown in this view) can be built using one or both of the build units, including by laser powder deposition. The build envelope could also be built by, e.g., welding. In general, any number of objects and build envelopes can be built simultaneously using the methods and systems of the present invention.

As mentioned above, a build unit (e.g., as shown in FIGS. 2 and 3) and/or multiple build units may be used to selectively provide a build material (e.g., powder) and at least partially melt or sinter the build material within a scan region. As the size of the component being manufactured using the AM apparatus increases, portions of the component may require a build unit to move to another scan zone. Further, portions of the build may require two or more scan zones to be connected to form a single larger at least partially solidified layer of the AM build. One simplified example is shown in FIG. 4. In FIG. 4, two build units 802A and 802B are mounted to a positioning system 801 which may allow the build units to move along an x, y, and z direction. Further, the positioning system 801 may allow the build units to rotate about axis 806 and 808. The positioning system may rely on a series of motors and sensors to move the build unit(s) precisely. For example, as shown in FIG. 4, a build unit 802A may fuse a region within a scan zone 812A. The build unit 802 may then move to a second scan zone 812B to fuse a second portion of the build to form a larger fused region within both scan zones 812A and 812B. Similarly, the build unit may fuse a region within a scan zone 814A and then may move to fuse a second portion of the build to form a larger fused region within both scan zones 814A and 814B. A build unit 802B may fuse a region within a scan zone 816A. The build unit 802B may then move to a second scan zone 816B to fuse a second portion of the build to form a larger fused region within both scan zones 816A and 816B. Further, it is possible to form a first fused region within a scan zone 818B using build unit 802B and form a second portion of the fused region within a scan zone 818A using build unit 802A. As the abovementioned example scenarios illustrate, fusing a layer of the AM build using a mobile build unit and/or multiple build units requires precise positioning of the build units. Thus, it becomes increasingly important to assure that the motors and sensors that move the build units are precisely calibrated to assure that the fused region within each scan zone matches up and properly meshes with a connected fused region within a subsequent scan zone.

Each of the scan regions may be selected by software which divides each layer of a desired AM build into build unit positions and raster-scan regions. Each scan region 812A-B, 814A-B, 816A-B and/or 818A-B may be formed using a series of solidification lines (not shown). Additional details for scan strategies that can be used in accordance with the present invention may be found in U.S. patent application Ser. No. 15/451,108, titled “Triangle Hatch Pattern for Additive Manufacturing,” with attorney docket number 037216.00070, and filed Mar. 7, 2017; U.S. patent application Ser. No. 15/451,043, titled “Leg Elimination Strategy for Hatch Pattern,” with attorney docket number 037216.00078, and filed Mar. 6, 2017; U.S. patent application Ser. No. 15/459,941, titled “Constantly Varying Hatch for Additive Manufacturing,” with attorney docket number 037216.00077, and filed Mar. 15, 2017, the disclosures of which are incorporated herein by reference.

Further, when a AM apparatus as shown in FIG. 3 is used. It may further be necessary to calibrate the mobile build platform 310. Accordingly, the invention is applicable to typical AM machines, as well as AM machines having mobile build unit(s) and mobile build unit(s) used in conduction with a mobile build platform (e.g., as shown in FIG. 3).

As mentioned above, a build unit (e.g., as shown in FIGS. 2 and 3) is used to selectively provide a build material (e.g., powder) and at least partially melt or sinter the build material within a scan region. As the size of the component being manufactured using the AM apparatus increases, portions of the component may require a build unit to move to another scan zone. Further, portions of the build may require two or more scan zones to be connected to form a single larger at least partially solidified layer of the AM build.

In one aspect of the disclosure, the solidification lines of each of a first scan region and the second scan region may be formed so as to interlock within the space between each scan region. The solidification lines may be formed so as to interlock at alternating intervals within space between the two scan regions. Additional details for interlocking solidification line schemes that can be used in accordance with the present invention may be found in U.S. Provisional Application No. 62/584,553, titled “Interlace Scanning Strategies and Uses Thereof,” to Gansler et al., with attorney docket number 037216.00156, and filed Nov. 10, 2017; and U.S. Provisional Application No. 62/584,482, titled “Scan Field Variation for Additive Manufacturing,” to Mamrak et al., filed Nov. 10, 2017 the contents of which are hereby incorporated by reference.

As mentioned above, as the size of the component being manufactured using the AM apparatus increases, portions of the component may require a build unit to move to another scan zone. Further, portions of the build may require two or more scan zones to be connected to form a single larger at least partially solidified layer of the AM build. When at least partially fusing and/or solidifying each layer of an AM build using a mobile build unit and/or multiple build units precise positioning of the build units is required. Thus, it becomes increasingly important to assure that the motors and sensors that move the build units are precisely calibrated to assure that the fused region within each scan zone matches up and properly meshes with a connected fused region within a subsequent scan zone. However, when moving a build unit, a certain amount of misalignment may occur from one scan zone to the next. While it may be possible to calibrate the movement of the build unit such that an amount of misalignment between scan zones is negligible, such a calibration may come at the cost of efficiency during the build process. Further, frequent calibration of the mechanical movement of the build unit may further hinder efficiency of the AM build process.

Further, while mobile build units and/or build platforms may have extremely accurate positioning systems, increasing the accuracy of the positioning system (e.g, a positioning system for a build unit, gantry for a build unit, robot arm for a build unit) may increase the cost of an AM apparatus significantly. By, employing the method and apparatus disclosed herein, a less accurate positioning system may be used without sacrificing quality of the completed component. For example, if a less accurate positioning system is used, the irradiation source directing apparatus may be adjusted to compensate for any misalignment in the positioning system. As one example, a irradiation source directing mechanism may be adjusted to compensate for a misalignment below a certain value between scan regions. For example, the irradiation source directing mechanism may be adjusted for a misalignment between a first scan region a the second scan region by offsetting at least one of the first scan region and the second scan region between 1 μm and less than the length or width of the first scan region. In a typical system, the length and width of the scan region may be 6 inches by 4 inches, respectively. In such a case where the offset approaches in size a dimension of the scan region, the useable build area may limit the size of the actual write area. However, that information may be taken into account in planning the scan strategy for the adjacent scan region. In systems capable of finer movement of the build unit, the needed offset may be much smaller in size. In this case, the offset may be between 1 μm and 10 mm, and preferably 1 μm and 1 mm. Thus, any inaccuracies associated with the positioning system would become negligible. Accordingly, employing the techniques mentioned throughout the disclosure could be employed to reduce the cost of an AM apparatus without a loss in AM build quality.

An amount of offset between scan fields may be determined by forming markings on the build material and reading the alignment between a single and/or plurality of markings either manually and/or using a offset detection portion (e.g., an optical sensor, a camera, an image sensor, photoelectric sensor). Additional details for alignment detection that can be used in accordance with the present invention may be found in U.S. Provisional Application No. 62/584,553, titled “Interlace Scanning Strategies and Uses Thereof,” to Mamrak et al., with attorney docket number 037216.00125, and filed Nov. 10, 2017, the contents of which are hereby incorporated by reference. An amount of offset can further be determined using any known method in the art.

Determining the offset between scan fields may also comprise a position sensor (not shown) that is separate from build unit 302, 400 and is configured for obtaining positional data of build unit 302, 400. As used throughout the disclosure, “position” and “positional data” may refer to any information or data indicative of the location and/or orientation of build unit 302, 400 within the three-dimensional build area (e.g., as shown in FIG. 4) and may include up to six degrees of freedom. In this regard, for example, positional data may refer to the position of build unit 302, 400 within a 3-D space as well as the angular position of build unit 302, 400 about three axes (e.g., pitch, yaw, and roll or rotation about the X-Y-Z axes). According to alternative embodiments, positional data may further include data associated with the velocity, acceleration, vibration, and trajectory of build unit 302, 400. In addition, it should be appreciated that “position,” as used herein, may be used generally to refer to the translational location of build unit 302, 400 within a three-dimensional space, the orientation of build unit 302, 400 within that space, or both. A position sensor may be employed at a located in a fixed position relative to a gantry.

The position detecting system mentioned above may include one or more position sensors positioned remote from the build unit for tracking the position of the build unit. The positioning system may further include a plurality of range finders or position sensors positioned on the build unit for detecting the distance to a known reference location or object (e.g., a support let, a wall, or any other object having a known location relative to the build platform. The positioning system may also use tracking targets to facilitate detection by the position sensors. In addition, multiple sensors may be used and a sensor fusion algorithm may be used to improve the detection of the position of the build unit.

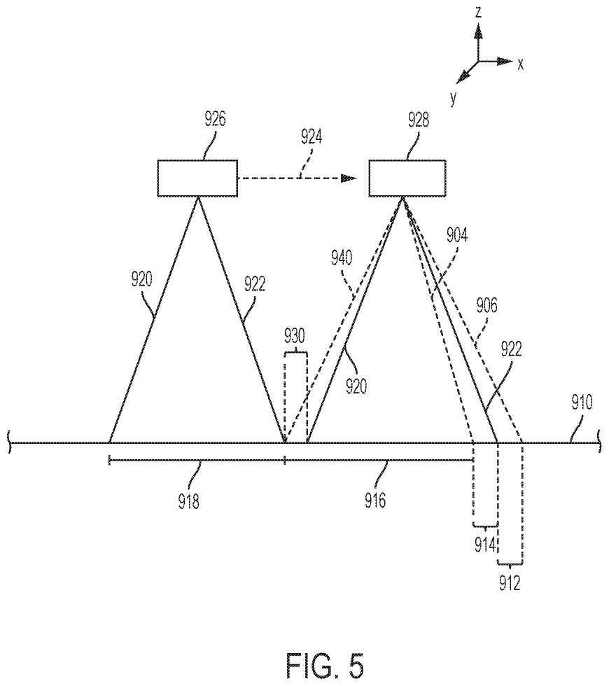

As shown in FIG. 5, a build unit (not shown) may include an irradiation portion(s) 926, 928. It is noted that FIG. 5 has been simplified and the irradiation portion(s) 926, 928 may be the irradiation beam directing mechanism 506 of the build unit shown in FIG. 3 and/or the irradiation emission directing device 401 shown in FIG. 2. Further it is noted that irradiation portion(s) 926 and 928 may represent a portion of a single build unit moving from a first location along path 924 to a second location or may represent two separate build units, for example. The irradiation portion(s) may be a single or multiple galvanometers for guiding a single or multiple lasers. Further, the irradiations portion(s) may also be a single or multiple electron beam(s) (“e-beam”).

As one example of an implementation of the disclosed method, a build unit (not shown as discussed above) may be positioned such that an irradiation portion 926 irradiates a first scan field covering a first portion of a build material 910 having a first length 918 in the X direction. As mentioned above, in one example, the irradiation portion 926 may be a galvanometer for directing a laser source over a scan region between set maximum scan angles 920 and 922. The term galvanometer, irradiation directing device, irradiation source directing mechanism and/or scanner may be used interchangeably throughout the specification. When the build unit moves to a second location in direction 924, the galvanometer may be in a second location 928. Using any of the abovementioned methods it may be determined that the movement of the build unit has resulted in an offset 930 between the first position of the build unit and the second position of the build unit. If the offset 930 is below a threshold value, it may be determined that the build unit position does not need to moved again by the build unit positioning device to correct the offset between the scan fields, as the galvanometer is capable of operating within the angular range necessary to compensate for the offset 930 between the first scan field and the second scan field. For example, the irradiation source directing mechanism may be adjusted for the misalignment 930 between a first scan region 918 and second scan region 916 by offsetting at least one of the first scan region 918 and the second scan region 916, wherein an offset distance is between 1 μm and less than the length or width of the first scan region. In another aspect, the offset may be between 1 μm and 10 mm.

Thus, instead of forming the second scan field with between the previously set maximum scan angles 920 and 922, the galvanometer may be adjusted to have maximum scan angles 940 and 904 so as to begin forming the second scan field having a second length 916 in the X direction. Further, because the scan field altered due to the adjustment of the galvanometer, for example a scan vector having a maximum angle 920 may be altered to a scan vector having a maximum angle 920, it may be necessary to adjust the scan vector having a maximum angle 922 to a scan vector having maximum angle 904 depending on the capabilities of the galvanometer and the loss of power in the laser at such an angle. Thus, if it is necessary to adjust the scan vector 922 to 904, the second scan field may be decreased in length in the X direction by a distance 914. However, if it is determined that the scan vector having a maximum angle may remain at 922, any subsequent scan fields formed would not require an adjustment of the movement of the build unit to compensate for the distance 914.

Further, as discussed below, based on a trending profile of the movement of the build unit and/or platform, it may be determined that a scan field formed adjacent to the second scan field will deviate by a distance 912 in the X direction. As long as it is determined that a laser power would remain acceptable and the galvanometer is capable forming a scan vector at an angle 906, the galvanometer 928 may be adjusted to compensate for a predicted deviation of the third scan vector which would be formed a distance 912 from the second scan vector. Thus, by determining that the irradiation directing portion(s) 926 and 928 may be adjusted to compensate for positional deviations of the build unit, a build process efficiency may be increased due to a decrease in excessive movement of the build unit.

In the example discussed above, the adjustment of the galvanometer may be accomplished by adding an offset value to the positional coordinates selected by the software discussed supra. Further, the galvanometer may be adjusted by altering a drive voltage of the galvanometer. For example, a drive voltage of the galvanometer in the X direction may be adjusted so that each scan vector is offset by a known distance corresponding to the adjustment in drive voltage. Similarly, a drive voltage of the galvanometer in the Y direction may be adjusted so that each scan vector is offset by a known distance corresponding to the adjustment in drive voltage.

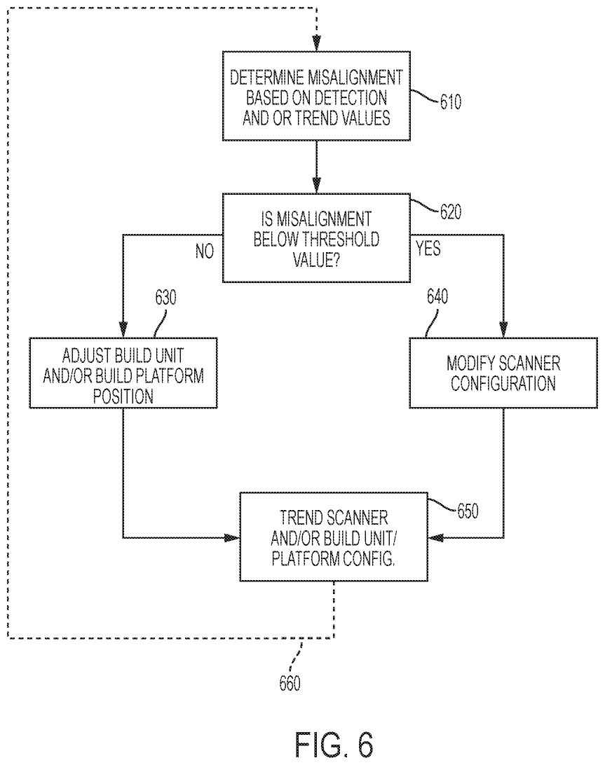

FIG. 6 shows an example flow diagram of the abovementioned process. In step 610 any of the abovementioned methods or any known method in the art may be used to determine a misalignment of two subsequent scan regions based on a deviation in the positioning mechanism of the build unit and/or a deviation in the positioning of the build platform. Once it is determined that a misalignment exists, at 620 the determination is made if the misalignment is above or below a threshold value. A threshold value may include a known maximum angle that the irradiation source and irradiation source directing mechanism can be used to at least partially solidify a build material. If it is determined that the misalignment is below a threshold value (e.g., a irradiation source and directing mechanism can be adjusted to compensate for the misalignment without having to adjust the positioning of the build unit itself). If it is determined that the misalignment is below a threshold value, the process may move on to step 640 and the scanner configuration is altered based on the detected and/or predicted misalignment. The scanner configuration may be altered using any of the methods discussed above, for example. If the misalignment is below or equal to a threshold value, the determination may be made that the build unit and/or build platform position needs to be adjusted. In both scenarios, the misalignments detected and/or the corrective actions taken for any of the misalignments may be stored as trending data which may be used to predict positional deviations in subsequent layers and/or to automatically trend related machine mechanism health. This process may be repeated for each subsequently formed scan region at step 660. As an alternative the process may be repeated at 660 at fixed or variable intervals based on the stored trending data.

By contrast, if it is determined that the misalignment is above a threshold value at step 620, step 630 may include adjusting the position of the build unit and/or the build platform. Step 650 may include configuring the trend scanner and/or the build unit/platform configuration.

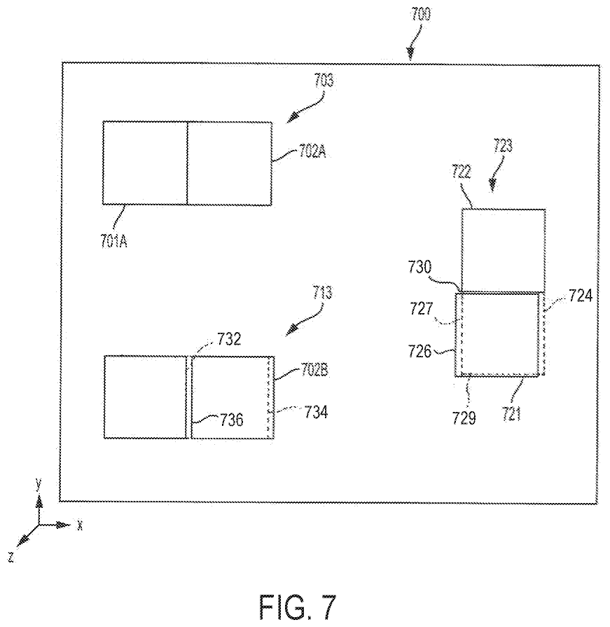

FIG. 7 shows various scan zones examples of possible alignment issues from one scan zone to another for an exemplary additive manufacturing machine 700. It is noted that the scan zones shown are solely for example purposes, and that one having ordinary skill in the art would understand that the examples shown are not exhaustive. Further, the alignment issues shown in FIG. 7 are exaggerated for illustration purposes. As one example shown in FIG. 7, a first scan zone 701A may be formed near a second scan zone 702A at two different positions of the same build unit or using two build units. As mentioned above, the AM apparatus may use a detector and/or use trend data to determine the offset between the scan fields. The group of scan fields 703 shows an example situation where a detector/sensor and a computer may determine that no additional offset value is needed. As mentioned above, it may be determined that the two scan zones 701A and 702A are properly aligned in the X and Y direction requiring no offset value to be incorporated into the operating parameters of the scanner.

A second example set of scan zones 713 shows a possible misalignment between a first scan zone 701B and a second scan zone 702B. The abovementioned trend data and/or sensor data may be used to determine an offset between the scan fields. The group of scan fields 713 shows an example situation where an observer and/or a detector/sensor and a computer may determine that misalignment has/will occur between the two scan fields. Based on the amount of misalignment, it may be determined that the scanner can be adjusted to compensate (e.g., using the process shown in FIG. 6). Accordingly, the scanner may be adjusted so that each of the scan vectors are moved in the negative X direction to prevent the formation of a gap between the two scan fields. By adjusting the scan vectors, the borders of the effective scan region would move from 702B to 734 and from 736 to 732.

A third example set of scan zones 723 shows a possible misalignment between a first scan zone 722 and a second scan zone 730. The abovementioned trend data and/or sensor data may be used to determine an offset between the scan fields. The group of scan fields 723 shows an example situation where an observer and/or analysis of trend data and/or a detector/sensor may determine that misalignment has/will occur between the two scan fields 722 and 730. Based on the amount of misalignment, it may be determined that the scanner can be adjusted to compensate (e.g., using the process shown in FIG. 6). Accordingly, the scanner may be adjusted so that each of the scan vectors are moved in the positive X direction and positive Y direction to prevent the formation of a gap between the two scan fields. By adjusting the scan vectors, the borders of the effective scan region would move from 726 to 727 in the X direction, and from 721 to 729 in the Y direction.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A method for forming an object using an additive manufacturing apparatus, the method comprising:
irradiating a build material to form a first solidified portion within a first scan region using an irradiation source of a build unit;
moving the build unit to a second scan region; and
irradiating a build material to form a second solidified portion within the second scan region, wherein an irradiation source directing mechanism is adjusted to compensate for a misalignment between the first scan region and the second scan region.

2. The method for forming the object of claim 1, wherein the irradiation source directing mechanism is adjusted by applying an offset value to a signal received at the irradiation source directing mechanism.

3. The method for forming the object of claim 1, wherein the irradiation source direction mechanism is a galvanometer.

4. The method for forming the object claim 1, wherein the irradiation source directing mechanism is adjusted by altering a drive voltage of the irradiation source directing mechanism.

5. The method for forming the object of claim 1, wherein the irradiation source directing mechanism is adjusted to compensate for a misalignment between the first scan region and the second scan region (640) by offsetting at least one of the first scan region and the second scan region, wherein an offset distance is between 1 μm and less than the length or width of the first scan region.

6. The method for forming the object of claim 1, wherein the offset distance is between 1 μm and 10 mm.

7. A non-transitory computer readable medium storing a program configured to cause a computer to execute an additive manufacturing method, the manufacturing method comprising:
irradiating a build material to form a first solidified portion within a first scan region using an irradiation source of a build unit;
moving at least one of the build unit and a build platform to irradiate a second scan region, wherein an irradiation source directing mechanism is adjusted to compensate for a misalignment between the first scan region and the second scan region.

8. The non-transitory computer readable medium storing the program of claim 7, wherein the irradiation source directing mechanism is adjusted applying an offset value to a signal received at the irradiation source directing mechanism.

9. The non-transitory computer readable medium storing the program of claim 7, wherein the irradiation source direction mechanism is a galvanometer.

10. The non-transitory computer readable medium storing the program of claim 7, wherein the irradiation source directing mechanism is adjusted by altering a drive voltage of the irradiation source directing mechanism.

11. The non-transitory computer readable medium storing the program of claim 7, wherein a build platform is moved to irradiate the second scan region.

12. The non-transitory computer readable medium storing the program of claim 7, wherein the build unit is moved to irradiate the second scan region.

13. The non-transitory computer readable medium storing the program of claim 7, wherein the irradiation source directing mechanism is adjusted to compensate for a misalignment between the first scan region and the second scan region by offsetting at least one of the first scan region and the second scan region, wherein an offset distance is between 1 μm and less than the length or width of the first scan region.

14. The non-transitory computer readable medium storing the program of claim 7, wherein the offset distance is between 1 μm and 10 mm.
